(19) United States
(12) Patent Application Publication
(10) Pub. No.: US 2011/0310072 A1
(43) Pub. Date: Dec. 22, 2011

(54) DISPLAY PANEL AND DISPLAY DEVICE

(75) Inventors: Kei Oyobe, Osaka (JP); Masahiro Adachi, Osaka (JP)

(73) Assignee: SHARP KABUSHIKI KAISHA, Osaka (JP)

(21) Appl. No.: 13/148,613

(22) PCT Filed: Oct. 16, 2009
(86) PCT No.: PCT/JP2009/067881

§ 371 Date: Aug. 9, 2011

(30) Foreign Application Priority Data
Feb. 12, 2009 (JP) 2009030010

(51) Int. Cl. G06F 3/038; G09G 3/30

(52) U.S. Cl. 345/207; 345/76

(57) ABSTRACT

A display part (1) for detecting an external input by means of a photo sensor (8) includes an active matrix substrate (4) including the photo sensor (8), an opposite substrate (6) facing the active matrix substrate (4), a liquid crystal layer (5) interposed between the active matrix substrate (4) and the opposite substrate (6), and a protective plate (3) that covers the surface of the opposite substrate (6) on the side opposite to the surface thereof adjacent to the liquid crystal layer (5). A non-flat portion (7) is formed on the protective plate (3) in a region that is a part of the surface on the side opposite to the surface contacting with the opposite substrate (6) and that faces the photo sensor (8), whereby a position on which contact is made from outside can be recognized more clearly.

### TECHNICAL FIELD

The present invention relates to a display panel having a touch panel function, and a display device including such a display panel.

### BACKGROUND ART

A display panel having a touch panel function, which can detect a touched position when a surface of the panel is touched by an input pen or a finger, is used in display devices such as liquid crystal display devices, for example. A resistive film system, a capacitance system or the like is mainly used for conventional touch panels, for example. Sensors are formed on the entire panel surface in these touch panels, and when a pressure is added to the panel surface by touching the panel surface with a pen or a finger, a position of the pen tip or the fingertip is detected.

Further, in recent years, technologies of including a display panel having a touch panel function in a mobile electronic device such as a mobile phone or a portable mobile device have been developed, and among those technologies is a display panel such as a liquid crystal panel or an organic EL (electro luminescence) panel with a built-in photo sensor, for example.

In a display panel having a touch panel function using a photo sensor, a position on which an input is made by a pen or a finger is detected by a change in light amount received by the photo sensor. In other words, when a panel surface is contacted by a pen or a finger, the light amounts emitted onto the photo sensor become different in the contact position and a noncontact position. Therefore, the contact position is detected based on a change in light amount received by the photo sensor in this display panel. Patent Document 1 discloses a touch panel that detects a contact position by photo sensors in such a manner. FIG. 10 is a view showing the configuration of a touch panel according to Patent Document 1. Specifically, FIG. 10(A) is an upper surface view showing the configuration of a conventional touch panel, and FIG. 10(B) is a cross-sectional view of the touch panel shown in FIG. 10(A).

As shown in FIG. 10(A) and FIG. 10(B), a touch panel 100 includes a light guide panel 101 having a transparent material, photo sensor arrays 110 and 120 disposed on sides of the light guide panel 101, and illumination means 112 and 122 that are disposed on sides of the light guide panel 101 and that emit light that will be received by the photo sensor arrays 110 and 120. This touch panel 100 electrically detects the position of a pen tip or a fingertip in accordance with a change in light amount received by the photo sensor arrays 110 and 120.

That is, when a pen or a finger touches a surface of the light guide panel 101, light is refracted or absorbed in the contact position, and therefore, light amount received by the photo sensor arrays 110 and 120 decreases. The position of a pen tip or a fingertip is detected based on such a change.

Besides this, Patent Document 2 discloses a backlight system display panel equipped with photo sensors.

### RELATED ART DOCUMENTS

### Patent Documents

Patent Document 1: Japanese Patent Application Laid-Open Publication No. 2000-172444 (Published date: Jun. 23, 2000)
Patent Document 2: Japanese Patent Application Laid-Open Publication No. 2007-102154 (Published date: Apr. 19, 2007)

### SUMMARY OF THE INVENTION

### Problems to be Solved by the Invention

As described above, a position touched by a pen or a finger is detected based on a change in the amount of light received by the photo sensors in a display panel having a touch panel function using photo sensors. In other words, in a display device including a display panel, a backlight is emitting light from a rear surface of the display panel, and when a pen or a finger touches a surface of the display panel, light from the backlight is reflected at that position. The light amount of the reflected light received by the photo sensors is different from the light amount of light incident from the exterior, and therefore, the photo sensors detect the contact position based on these light amount changes.

Here, in mobile electronic devices including a display panel such as a liquid crystal panel or an organic EL panel, a transparent protective cover, which is made of acrylic or polycarbonate resin or the like, for example, is often formed on an upper surface of the display panel due to the design of the devices in recent years.

However, in this configuration, a display panel is contacted through the protective cover, and the distance between a position on which a contact is made by a pen or a finger and a photo sensor formed in the display panel becomes large. As a result, a photo sensor corresponding to a noncontact position may receive light from the backlight reflected at the contact position, and a photo sensor corresponding to the contact position may receive external light, for example.

As just described, in a display panel including a photo sensor, especially in a display panel in which a contact position is distant from a photo sensor, the difference in light amount between the light received by a photo sensor corresponding to the contact position and the light received by a photo sensor corresponding to the noncontact position is not likely to be apparent. As a result, it is difficult to determine the contact position because the intensity ratio between light from the backlight reflected in the contact position and external light incident upon the noncontact positions is small.

The present invention was devised in light of the above-mentioned problems, and its object is to provide a display panel having a touch panel function using a photo sensor that can recognize a position at which a contact is made from outside with more accuracy.

### Means for Solving the Problems

The display panel of the present invention is a display panel for detecting an external input using a photo sensor in order to resolve the above-mentioned problem, and includes: a first substrate including the above-mentioned photo sensor; a second substrate facing the first substrate; a display layer interposed between the first substrate and the second substrate; and a cover layer covering a surface of the second substrate on a side opposite to the surface that is adjacent to the above-mentioned display layer, wherein a non-flat portion is formed in the above-mentioned cover layer in a region, which is a part of a surface opposite to a surface that is in contact with the second substrate, and which corresponds to the above-mentioned photo sensor.

According to the above-mentioned configuration, a display panel for detecting an external input using a photo sensor includes: a first substrate including a photo sensor; a second substrate facing the first substrate; a display layer interposed between the first substrate and the second substrate; and a cover layer covering a surface of the second substrate on the side opposite to the surface that is adjacent to the display layer, wherein a non-flat portion is formed in the cover layer in a region corresponding to the above-mentioned photo sensor.

That is, in the display panel of the present invention, the photo sensor may be formed at a location at which a position on which contact is made from outside is detected, and the non-flat portion is formed in the cover layer in a region corresponding to the photo sensor, for example. Here, the non-flat portion means a non-flat region in which a recess or a projection is formed.

In this display panel, when a surface of the display panel is contacted through the cover layer by an input action of an input pen, a finger or the like, for example, light emitted from a light source onto the display panel is reflected at this contact position. Here, when a non-flat portion is present in the contact position, light emitted from the light source is reflected at the non-flat portion. As described above, the photo sensor is present at a location at which a contact position is being detected, and the non-flat portion is formed in a region corresponding to this photo sensor, and therefore, light reflected the non-flat portion is received by the photo sensor.

Meanwhile, when the non-flat portion is present at a position at which no contact is made from outside, for example, external light that is in the incident path to the photo sensor is refracted or reflected at the non-flat portion. Accordingly, even when external light enters the incident path to the photo sensor, it is possible to lower the intensity of external light that is received by the photo sensor because of the non-flat portion.

In such a manner, in the display panel of the present invention, the non-flat portion, which is formed in the cover layer, reduces light amount of external light incident to the photo sensor, and reflects light from the light source reflected at a position at which contact is made from outside so as to let the light enter to the photo sensor. As a result, it is possible to recognize the position at which a contact is made from outside with more accuracy.

Further, as described above, because the non-flat portion is formed at a position at which contact is to be made from outside, a user touches the non-flat portion when he/she performs an input action, and inputs can be recognized not only by a sense of vision but also by a sense of touch. Therefore, it is user-friendly and comfortable to use.

Moreover, it is preferable that the display panel of the present invention further include a light collection layer having a lens to collect light, wherein the above-mentioned lens is disposed such that the above-mentioned photo sensor is positioned on an optical axis thereof.

With this configuration, the display panel of the present invention includes a light collection layer that collects light by a lens, and the lens is disposed such that the photo sensor is positioned on an optical axis thereof. That is, the lens having a light collecting function is positioned between the non-flat portion, which is formed in the cover layer, and the photo sensor in a region corresponding to the non-flat portion. Therefore, it is possible to collect light from the light source that has been reflected at the non-flat portion by the lens, and to make the light enter to the photo sensor.

Meanwhile, because external light incident to the lens is defocused by the lens, the intensity of external light incident to the photo sensor is lowered. Therefore, it is possible to recognize the position at which contact is made from outside with more accuracy.

In the display panel of the present invention, it is also preferable that a material of the above-mentioned cover layer include an acrylic or polycarbonate resin.

With this configuration, the cover layer is formed of acrylic or polycarbonate resin in the display panel of the present invention. Therefore, the cover layer does not prevent transmission of light emitted from the backlight or light incident to the photo sensor after being reflected at a finger or the like, and therefore, it does not significantly affect visibility of an image displayed on the display panel. Further, a material other than acrylic or polycarbonate resin may be used for the cover layer as long as the material does not prevent image recognition, transmission of light emitted from the backlight, or light incident to the photo sensor after being reflected at a finger or the like, and does not significantly affect the display visibility.

Moreover, in the display device of the present invention, it is preferable that the above-mentioned non-flat portion be formed in an outer periphery of the above-mentioned cover layer.

With this configuration, when an input action is performed by sliding a finger or the like, for example, because the non-flat portion is formed at a position at which the input action is to be performed, it is possible to recognize the position at which contact is made from outside with more accuracy as well as to improve user-friendliness and comfort in use.

In the display panel of the present invention, it is also preferable that the above-mentioned non-flat portion be formed of a recessed and projected pattern.

The display device of the present invention includes the display panel of the present invention in order to resolve the above-mentioned problems.

According to the above-mentioned configuration, because the display device includes the display panel of the present invention, the intensity of external light received by the photo sensors is reduced, and light from the light source is reflected at the non-flat portion, which is formed at the position of an input action on the display screen, so that more light is received by the photo sensors. Therefore, it is possible to recognize the position at which contact is made from outside with more accuracy as well as to improve user-friendliness.

It is also preferable that the above-mentioned display panel be a liquid crystal display panel or an EL display panel in the display device of the present invention. Further, it is preferable that the display device of the present invention be a mobile information terminal or a mobile phone terminal.

### EFFECTS OF THE INVENTION

The present invention is a display panel for detecting an external input using a photo sensor, and includes a first substrate including the above-mentioned photo sensor, a second substrate facing the first substrate; a display layer interposed between the first substrate and the second substrate; and a cover layer covering a surface of the second substrate on the side opposite to the surface that is adjacent to the above-mentioned display layer, in which a non-flat portion is formed in the above-mentioned cover layer in a region, which is a part of a surface opposite to a surface in contact with the second substrate, and which corresponds to the above-mentioned photo sensor. Therefore, it is possible to recognize a position at which contact is made from outside with more accuracy.

Other purposes, characteristics and advantages of the present invention should be sufficiently understood by the description below. Moreover, advantages of the present invention will be made apparent by the following descriptions with reference to the attached figures.

### BRIEF DESCRIPTION OF THE DRAWINGS

FIG. 1 is a cross-sectional view showing the configuration of a display panel according to Embodiment 1 of the present invention.

FIG. 2 is a view showing a travel path of light in a non-flat portion at a noncontact position in the display panel of Embodiment 1 of the present invention.

FIG. 3 is a view showing a travel path of light in a non-flat portion at a contact position in the display panel of Embodiment 1 of the present invention.

FIG. 4 is a view showing a travel path of light in a non-flat portion at a noncontact position in the display panel of Embodiment 1 of the present invention.

FIG. 5 is a view showing a travel path of light in a non-flat portion at a contact position in the display panel of Embodiment 1 of the present invention.

FIG. 6 is a cross-sectional view showing the configuration of a display panel of Embodiment 2 of the present invention.

FIG. 7 is a view showing a travel path of light in a non-flat portion at a noncontact position in the display panel of Embodiment 2 of the present invention.

FIG. 8 is a view showing the exterior appearance of a display panel according to Embodiment 3 of the present invention.

FIG. 9 is a view showing the exterior appearance of a display panel according to Embodiment 4 of the present invention.

FIG. 10 is a view showing the configuration of a conventional touch panel.

### DETAILED DESCRIPTION OF EMBODIMENTS

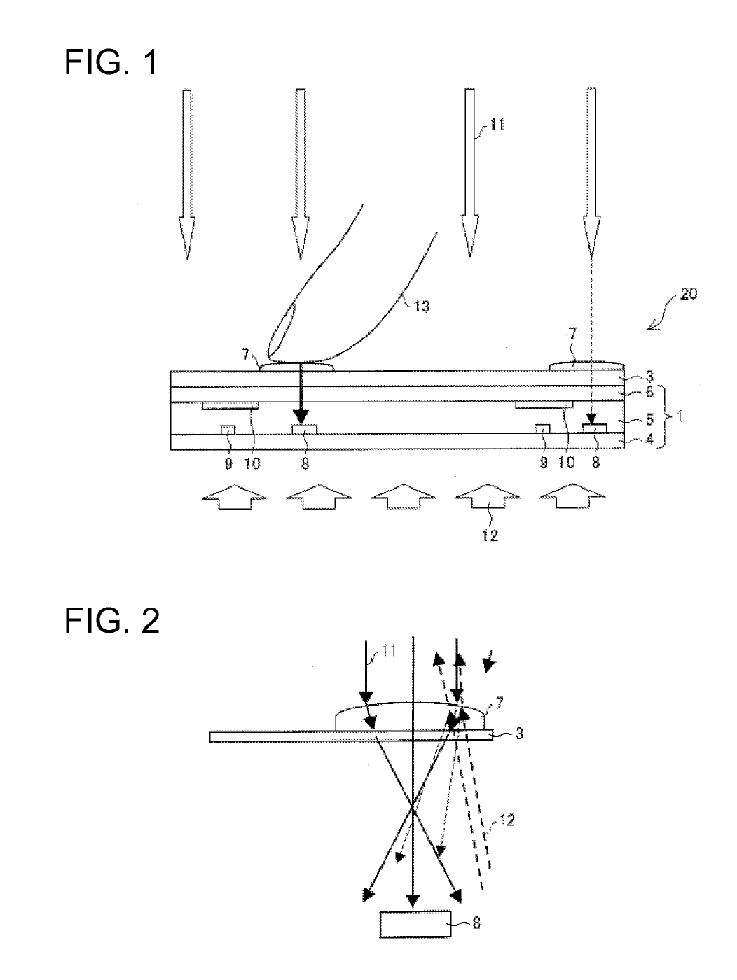

Embodiments of the display panel of the present invention will be described below with reference to FIGS. 1 to 9.

### Embodiment 1

### Configuration of a Display Panel 20

FIG. 1 is a cross-sectional view showing the configuration of the display panel 20 of the present embodiment. As shown in FIG. 1, the display panel 20 mainly includes a display part 1 and a protective plate (cover layer) 3.

The display panel 20 of the present embodiment is a display panel 20 for detecting an external input by optical sensors 8, and includes the display part 1 including the optical sensors 8, the protective plate 3 covering the surface of the display part 1 on the side opposite to the surface on which light is emitted from a light source, and non-flat portions 7 formed on the protective plate 3 in a region corresponding to the photo sensors 8.

The non-flat portions 7, which are formed in the protective plate 3, reduce the light amount of external light 11 incident to the photo sensors 8, and reflect backlight light 12 reflected at a position at which contact is made from outside such that the light enter the photo sensors 8. As a result, it is possible to recognize the position at which contact is made from outside with more accuracy.

The display part 1 includes a touch panel function through the photo sensors 8, and displays an image as well as detects a position at which contact is made from outside. The display part 1 of the present embodiment includes an active matrix substrate (first substrate) 4, a liquid crystal layer (display layer) 5, and an opposite substrate (second substrate) 6, as shown in FIG. 1.

In other words, the display part 1 has a configuration in which the liquid crystal layer 5 is held between the active matrix substrate 4 and the opposite substrate 6. In this display part 1, the photo sensors 8 that are built in the active matrix substrate 4 detect an input action from outside, which is based on an image displayed on the liquid crystal layer 5. Details of the display part 1 will be described later.

The protective plate 3 covers a surface of the display part 1 in order to protect the surface of the display part 1 or to apply a design to the panel, for example, and convex non-flat portions 7 are formed on the protective plate 3 in the display panel 20 of the present embodiment.

In other words, in the display panel 20, the protective plate 3 covers a surface of the opposite substrate 6 on the side opposite to the surface that is adjacent to the liquid crystal layer 5, that is, an upper surface of the opposite substrate 6 in FIG. 1. The non-flat portions 7 are formed on this protective plate 3 in a region that is a part of the surface opposite to the surface in contact with the opposite substrate 6 and that faces the photo sensors 8.

Here, the non-flat portion 7 means a non-flat region in which a recess or a projection is formed. Accordingly, it is possible to recognize a position at which contact is made from outside with more accuracy in the display part 1 including the photo sensors 8. Further, details of the non-flat portions 7 will be described later.

Display Part 1

As described above, the display part 1 includes a touch panel function using the photo sensors 8, and displays an image in the liquid crystal layer 5 as well as detects an external input by the photo sensors 8 that are built in the active matrix substrate 4.

There is no special limitation to the form of the display part 1 as long as the photo sensors 8 are included. A liquid crystal panel including a liquid crystal layer, and an OLED panel including an organic light emitting diode (OLED) layer are included, for example.

Moreover, the active matrix substrate 4 is a substrate in which a plurality of pixels are disposed in a matrix, and a plurality of TFTs (thin film transistors) 9 and the photo sensors 8 are disposed in an upper surface of the active matrix substrate 4.

The photo sensors 8 detect a contact position based on a change in light amount of the received light. In other words, in the display panel 20 of the present embodiment, the backlight light 12 is emitted from the lower side of the display part 1, and when a light shielding object 13 touches the surface of the display part 1, the backlight light 12 is reflected at the touched position. Here, the photo sensors 8 detect the contact position based on the intensity ratio of the light reflected at the contact position to the external light 11 incident from outside.

Here, the light shielding object 13 in the present specification means an object that blocks light, such as the backlight light 12 and the external light 11, for example. The light shielding object 13 includes a finger, an input pen or the like, for example.

The contact position means a region on the surface of the display part 1 at which contact is made by the light shielding object 13, and specifically means a region facing the photo sensor 8 in the present embodiment. Moreover, the noncontact position means a region on the surface of the display part 1 other than the contact position, and means a region facing the photo sensor 8 in a similar manner. Further, there is no special limitation to the number and the position of the photo sensors 8 to be disposed, and the photo sensor may be disposed in a region provided for detecting external input, for example.

The liquid crystal layer 5 is a display medium for displaying an image. In other words, the liquid crystal layer 5 displays an image with respect to which an input action from outside is received. As a result, a user determines which position to touch based on the image displayed in the liquid crystal layer 5 through the opposite substrate 6. Further, the liquid crystal layer 5 is used as a display layer in the present embodiment, but it is not limited to this, and an organic light emitting diode layer may also be used, for example.

The opposite substrate 6 is disposed so as to face the active matrix substrate 4, and a light shielding layer 10 is formed on the opposite substrate 6. This light shielding layer 10 should be formed at a location other than a region in which the photo sensors 8 and the non-flat portions 7 are facing to each other, and it may be formed at a position that can prevent light that has contacted the non-flat portions 7 from entering to the TFTs 9, for example. With this, it is possible to block external light 11 incident through a region on the protective plate 3 in which the non-flat portions 7 are not formed. Furthermore, for example, when the light shielding layers 10 are formed at locations corresponding to the TFTs 9, it is possible to prevent so-called light leakage or the like due to a liquid crystal orientation disorder, which may occur at the TFTs 9, or CF steps, which are not shown in the figure, or the like, or to prevent characteristic degradation of the TFTs 9 due to light.

Protective Plate 3

The protective plate 3 covers the upper surface of the display part 1 as described above, and the non-flat portion 7 is formed in a region that is a part of the surface opposite to the surface in contact with the display part 1, and that faces the photo sensor 8. Accordingly, in the display panel 20 including the photo sensors 8, even if a contact position is distant from the photo sensors 8, because the protective plate 3 is formed, a position at which contact is made from outside can be recognized with more accuracy.

In other words, in the display panel 20 of the present embodiment, the non-flat portion 7, which has a hemispherical projection and has been made non-flat, is formed on the protective plate 3. These non-flat portions 7 are formed in regions corresponding to the optical sensors 8 as described above. At the non-flat portion 7 on which no contact is made from outside, external light 11 that is incident at an angle at which it would be received by the photo sensor 8 is refracted or reflected at the non-flat portion 7, for example. As a result, even if the external light 11 enters to the non-flat portion 7 that is located along the incident path towards the optical sensors 8, the intensity of the external light 11 received by the photo sensors 8 can be lowered.

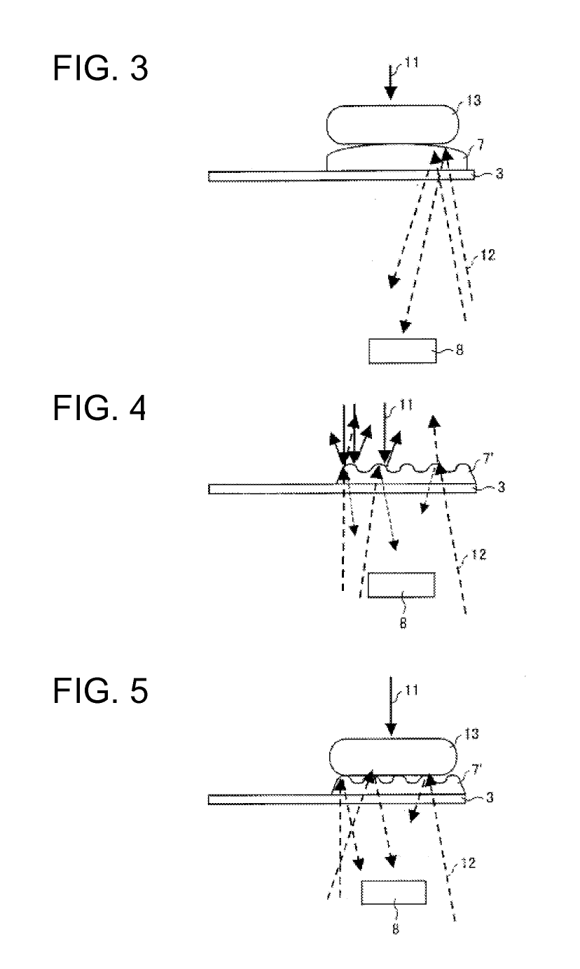

Meanwhile, at the non-flat portion 7 on which contact is made from outside, when the backlight light 12 contacts the non-flat portion 7, for example, the light is reflected so as to follow the incident path to the photo sensor 8. Here, the travel path of light that has contacted the non-flat portion 7 will be described with reference to FIGS. 2 and 3.

FIG. 2 is a view showing the travel path of light at the non-flat portion 7 located at a noncontact position, and FIG. 3 is a view showing the travel path of light at the non-flat portion 7 located at a contact position.

As shown in FIG. 2, the non-flat portion 7 is formed on the protective plate 3 by a hemispherical projection. When external light 11 enters the non-flat portion 7 on which no contact is made from outside, for example, the external light 11 incident to approximately the center of the non-flat portion 7 travels in a straight line, but the external light 11 incident to positions off the center is refracted in the non-flat portion 7, and does not follow the incident path towards the photo sensor 8.

When the backlight light 12 passes through the display part 1 and contacts the non-flat portion 7, a part of the backlight light 12 transmits through the non-flat portion 7, and the rest is reflected at the non-flat portion 7 and re-enters to the display part 1.

On the other hand, in the non-flat portion 7 on which contact is made from outside, as shown in FIG. 3, when the backlight light 12 contacts the non-flat portion 7, most of the backlight light 12 is reflected so as to follow the incident path to the photo sensor 8.

Accordingly, because the non-flat portion 7 is formed at a position corresponding to the photo sensor 8, the display panel 20 of the present embodiment reduces light amount of external light 11 incident onto the photo sensor 8, and reflects the backlight light 12, which is reflected at the non-flat portion 7 on which contact is made from outside, along the incident path towards the photo sensor 8. Therefore, even when the protective plate 3 is formed on the upper surface of the display part 1, for example, it is possible to recognize the position at which contact is made from outside with more accuracy.

There is no special limitation for a material of the protective plate 3 as long as it does not prevent transmission of the backlight light 12 or light reflected at the light shielding object 13. But it is preferable to include an acrylic or polycarbonate resin, for example. This way, there is no significant impact on visibility of an image displayed in the display part 1.

Further, the shape of the non-flat portion 7 may be a hemispherical projection as described above or minute recesses and projections as shown in FIGS. 4 and 5, for example. FIG. 4 is a view showing the travel path of light at a non-flat portion 7′ at a noncontact position, and FIG. 5 is a view showing the travel path of light at a non-flat portion 7′ at a contact position.

As shown in FIG. 4, a part of the backlight light 12 that contacted the non-flat portion 7′ at the noncontact position transmits through the non-flat portion 7′, and the rest is reflected at the non-flat portion 7′ and re-enters the display part 1, similarly to the non-flat portion 7 formed by the hemispherical projection described above. On the other hand, external light 11 is reflected by the minute recesses and projections, and most of it does not enter the display part 1.

Meanwhile, at the non-flat portion 7′ at the contact position, more backlight light 12 is reflected along the incident path towards the photo sensors 8, compared to the non-flat portion 7 formed of a hemispherical projection as shown in FIG. 5.

Accordingly, when the non-flat portion 7′ is formed of minute recesses and projections, most of the external light 11 that contacts the non-flat portion 7′ is reflected, and therefore, it is possible to lower the intensity of the external light 11 received by the photo sensor 8. Therefore, it is possible to recognize the position at which contact is made from outside with more accuracy. Here, their shape may be formed by a surface treatment such as embossing, for example.

Furthermore, a region in which the non-flat portion 7 is formed on the protective plate 3 should include a region that is a part of the surface in contact with the opposite substrate 6 and that faces the photo sensor 8. But, it is preferable that that region be at a position for detecting a position on which contact is made from outside, for example.

With this structure, when that position is not contacted from outside, the external light 11 is not likely to be received by the photo sensor 8, which is formed in a region corresponding to the non-flat portion 7. Further, when that position is contacted from outside, the backlight light 12 that contacts the non-flat portion 7 is reflected along the incident path towards the photo sensor 8. Therefore, it is possible to recognize with more accuracy the ratio of the intensity light received by the photo sensor 8 corresponding to a position at which contact is made from outside to the intensity of light received by the photo sensor 8 corresponding to a position at which no contact is made from outside.

Moreover, as described above, the non-flat portion 7 is formed at a position at which contact is to be made from outside, and therefore, a user can recognize his/her input not only by vision, but also by a sense of touch because he/she touches the non-flat portion 7 when performing an input action. Therefore, it is user-friendly and comfortable to use.

Such a region may be the outer periphery of the protective plate 3, or a plurality of circles may be scattered on the protective plate 3, for example. Furthermore, the protective plate 3 is used as a cover layer for covering the display part 1 in the display panel 20 of the present embodiment, but the cover layer is not limited to this, and a thin film such as a film may be used as well, for example.

It is preferable that the display panel 20 of the present embodiment be incorporated into a display device, for example. When the display panel 20 of the present embodiment is used for the display screen of a display device, for example, it becomes easier to recognize a contact position and a noncontact position with accuracy, and user-friendliness can be improved. Such a display device may be a mobile electronic device such as a mobile information terminal (PDA) or a mobile phone terminal, for example. Moreover, besides these, the applicable display device includes a device having a display function as a non-primary function, such as a key board having a display function added to the keyboard buttons themselves or the like.

Further, the display panel of the present invention may be a liquid crystal display panel or an EL display panel, for example, but is not limited to these, and other kinds of display panels are possible. A display device including these display panels may further include a plurality of display panels. It is possible to create a mobile information terminal with two screens, which includes two display panels having a touch panel function, for example.

### Embodiment 2

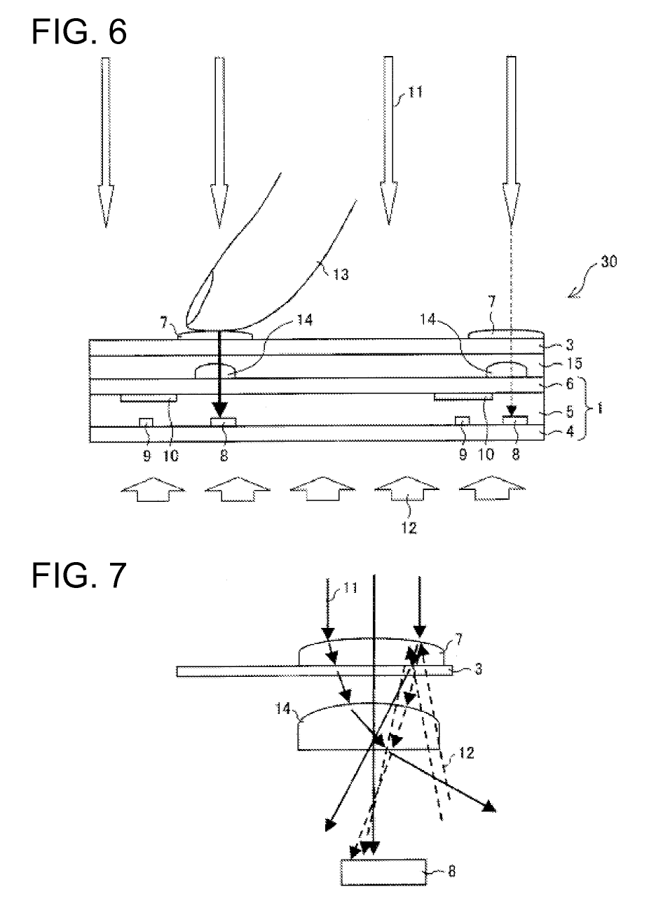

Next, Embodiment 2 of the present invention will be described with reference to FIGS. 6 and 7. FIG. 6 is a cross-sectional view showing the configuration of a display panel 30 of Embodiment 2, and FIG. 7 is a view showing the travel path of light at the non-flat portion 7 of a noncontact position.

As shown in FIG. 6, Embodiment 2 is similarly configured to Embodiment 1 except an aspect that Embodiment 2 further includes a light collection layer 15 including lenses 14 between the opposite substrate 6 and the protective plate 3.

The display panel 30 of the present embodiment collects light using the lenses 14 formed in the light collection layer 15. In other words, the display panel 30 includes the light collection layer 15 having the lenses 14 between the opposite substrate 6 and the protective plate 3, and the lens 14 is disposed such that the photo sensor 8 is positioned on the optical axis of the lens.

Accordingly, in the display panel 30 of the present embodiment, the lenses 14 having light collecting function are positioned between the non-flat portions 7, which are formed on the protective plate 3, and the photo sensors 8 in regions corresponding to the non-flat portions 7. Therefore, it is possible to collect backlight light 12 reflected at the non-flat portions 7 by the lenses 14 and to let the light enter the photo sensors 8. Meanwhile, because external light 11 incident to the lenses 14 is defocused by the lenses 14, the incident intensity of external light 11 to the photo sensors 8 becomes lowered. As a result, it is possible to recognize the contact position and the noncontact position with more accuracy.

Furthermore, the position of the lense 14 is not limited to a region between the display part 1 and the protective plate 3 described above as long as the photo sensor 8 is positioned on the optical axis. The lenses 14 may be disposed between the active matrix substrate 4 and the opposite substrate 6, for example. In this case, it is not necessary to form the light collection layer 15.

### Embodiment 3

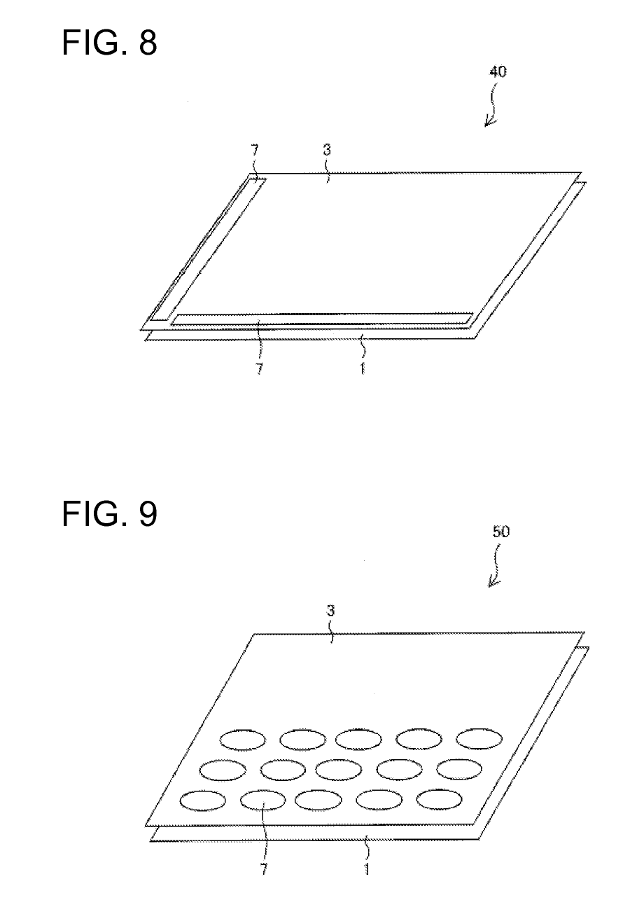

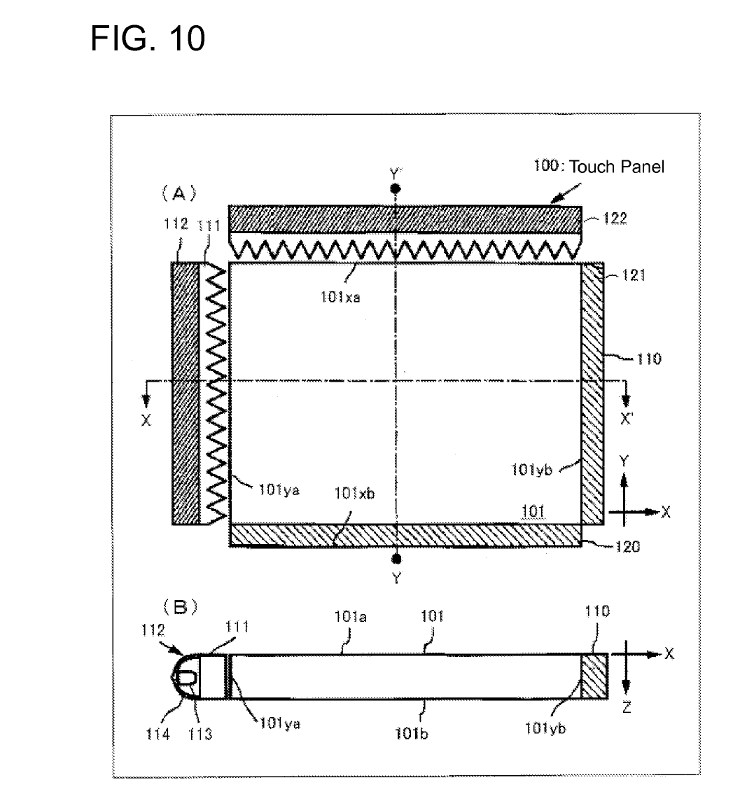

Next, Embodiment 3 of the present invention will be described with reference to FIG. 8. FIG. 8 is a view showing the exterior appearance of a display panel 40 according to Embodiment 3.

Embodiment 3 shows an example of regions on an upper surface of the protective plate 3 in which the non-flat portions 7 are formed. In the present embodiment, the non-flat portions 7 are formed in the outer periphery of the protective plate 3 as shown in FIG. 8, and other basic configuration is similar to Embodiment 1.

That is, an input action by sliding a finger or the like is intended in the display panel 40 of the present embodiment. Therefore, as a result of forming the non-flat portions 7 at a position at which an input action is to be performed (outer periphery in the present embodiment), it becomes easier to recognize the contact position and the noncontact position with accuracy, and user-friendliness and comfort in usage can be improved.

### Embodiment 4

Next, Embodiment 4 of the present invention will be described with reference to FIG. 9. FIG. 9 is a view showing the exterior appearance of a display panel 50 according to Embodiment 4.

Embodiment 4 also shows an example of regions on an upper surface of the protective plate 3 in which the non-flat portions 7 are formed. In the present embodiment, the non-flat portions 7 are formed on the upper surface of the protective plate 3 as a plurality of circles as shown in FIG. 9, and other basic configuration is similar to Embodiment 1.

That is, it is intended that an input action is performed by touching or sliding over a single or multiple non-flat portions 7 among a plurality of the non-flat portions 7 each formed in a circle shape in accordance with an image of numbers or characters, for example, displayed on the display part 1 of the display panel 50 of the present embodiment. Therefore, as a result of forming the non-flat portions 7 of positions at which an input action is to be performed (an image of numbers or characters displayed on the display part 1 in the present embodiment), it becomes easier to recognize the contact position and noncontact position with accuracy, and user-friendliness and comfort in use can be improved.

Further, the above-described embodiments are embodiments in which the non-flat portions 7 are formed on a part of the protective plate 3, but are not limited to these, and the non-flat portions 7 may be formed on a part of the opposite substrate 6, for example. Moreover, if a sheet or a substrate is provided on the opposite substrate for the purpose of display control, such as visibility control for display quality improvement or privacy protection, for example, the non-flat portions 7 may be formed on a part of such a sheet or the substrate.

The present invention is not limited to the respective embodiments described above, and various modifications are possible within the scope indicated in the claims, and the technical scope of the present invention includes embodiments that can be obtained by appropriately combining technical features disclosed in respective embodiments.

The specific embodiments or examples provided in the section of the detailed description of embodiments are meant to explain the technical content of the present invention, and should not be narrowly interpreted by limiting to such specific examples only, and various modifications are possible within the spirit and the scope of the claims of the present invention provided below.

### INDUSTRIAL APPLICABILITY

The present invention is suited for a mobile electronic device such as a mobile information terminal (PDA) or a mobile phone terminal including a display panel such as a liquid crystal panel or an OLED panel, for example.

### DESCRIPTION OF REFERENCE CHARACTERS

1 display part
3 protective plate (cover layer)
4 active matrix substrate (first substrate)
5 liquid crystal layer (display layer)
6 opposite substrate (second substrate)
7 non-flat portion
8 photo sensor
9 TFT
10 light shielding layer
20, 30, 40, 50 display panels

1. A display panel for detecting an external input using a photo sensor, comprising:
a first substrate including said photo sensor;
a second substrate facing the first substrate;
a display layer interposed between the first substrate and the second substrate; and
a cover layer covering a surface of the second substrate on a side opposite to a surface that is adjacent to said display layer,
wherein a non-flat portion is formed on said cover layer in a region that is a part of a surface opposite to a surface in contact with the second substrate, and that faces said photo sensor.

2. The display panel according to claim 1, further comprising:
a light collection layer having a lens to collect light,
wherein said lens is disposed such that said photo sensor is positioned on an optical axis thereof.

3. The display panel according to claim 1, wherein a material of said cover layer includes an acrylic or polycarbonate resin.

4. The display panel according to claim 1, wherein said non-flat portion is formed in an outer periphery of said cover layer.

5. The display panel according to claim 1, wherein said non-flat portion is formed of a recessed and projected pattern.

6. A display device, comprising:
the display panel according to claim 1.

7. The display device according to claim 6, wherein said display panel is a liquid crystal display panel or an EL display panel.

8. The display device according to claim 6, wherein the display device is a mobile information terminal or a mobile phone terminal.
